(19) United States
(12) Patent Application Publication
(10) Pub. No.: US 2002/0145762 A1
(43) Pub. Date: Oct. 10, 2002

(54) Optical chassis pasted with plating film reflection thin plates

(76) Inventors: Chuan-Yu Hsu, Hsinchu (TW); Chih-Wen Huang, Hsinchu (TW)

Correspondence Address: Raymond Sun, 12420 Woodhall Way, Tustin, CA, 92782, US

(21) Appl. No.: 09/827,063

(22) Filed: Apr. 5, 2001

(51) Int. Cl. H04N 1/21; H04N 1/04

(52) U.S. Cl. 358/302

(57) ABSTRACT

An optical chassis pasted with plating film reflection thin plates includes: a shell body, a light source, plural reflection elements, a lens set, and an imaging apparatus. The thin plates of flexible material in lieu of prior glass material constitute the reflection elements. The reflection material is plated on one side surface of the thin plates, and the glue is coated on the other side surface of the thin plates. The thin plates, coated with glue, may be directly pasted onto appropriate positions of an optical chassis as the reflection elements. Not only the present invention completely gets rid of the prior positioning devices, such as spring pieces, screws, and the like, but also it decreases the number of parts, saves assembly time and lowers the production cost. And, further it is without lowering the quality of image scanning, which is resulted from no loose or no movement of the reflection elements. In addition, for practical needs, the thin plate with flexible material may be easily bent or manufactured to curved face or irregular shape according to requirement.

### BACKGROUND OF THE INVENTION

1. Field of the Invention

The present invention relates to an optical chassis pasted with plating film reflection thin plates, especially to a kind applied in an optical scanner, in which one side surface of the flexible thin plate is plated with a layer of reflection material as a reflection mirror.

2. Description of the Prior Art

Please refer to FIG. 1, which is an embodiment of an optical scanner 1 of flat bed of typical type and can be seen in current market. The major feature is a document window glass 12 provided on the upper surface of an outer shell 11 of a scanner 1 to support a document (not shown in the figure) waiting for scanning. An image scanning job carries out on the document put on the glass 12 by a driving device 13 to activate an optical chassis 14 inside a hollow shell 11 to make a linear motion along a guiding rod 14.

Please refer to FIG. 2, which is an A-A cross-section view of the optical chassis of the prior optical scanner 1 shown in FIG. 1. The optical chassis includes: a hollow shell body 141, a light source 142 positioned on an appropriate position of the upper surface of the shell body 141, plural reflection mirrors 143, a lens set 144, and a charge-coupling device (CCD) 145. The light source 142 emits light onto the document (not shown in the figure) put on the glass 12. After the reflected light enters into the shell body 141 of the optical chassis 14, the light is reflected several times to increase its optical length to an appropriate length by the plural refection mirrors 142. The light is focused into an image on the charge-coupling device 145 by the lens set 144, and the scanned image is changed into electronic signals.

As the prior optical chassis 14 shown in FIG. 1 and FIG. 2, because the sliver plated on the pieces of glass constructs the reflection mirrors 143, it is necessary to fix the mirrors on the predetermined positions inside the shell body 141 by spring piece 146, fixture devices or in accordance with screw fixtures. Not only the additional positioning elements including spring pieces 146, fixture devices and the like will directly cause the increase of the production cost and the number of parts, no further reduction of the size of optical chassis due to shortage of space occupied by too many parts, and the raise of assembly time and labor cost, but also as the number of assembly parts increases, it will happen the inevitable situation of quality lowering down for scanned images caused by the deviated position of reflection mirrors, which is caused by the parts loose and uneven strength of holding. Furthermore, in prior arts, by applying the spring pieces 146 as the fixture devices for holding the reflection mirrors 143, in long term, it will cause an elasticity fatigue for the spring pieces 146 and weaken the holding strength, or under the situation of vibration caused by the transportation of machine, it may happen the situation of loose or position deviation for reflection mirrors 143 and cause the quality lowering down for scanned images, and they are all waiting for further improvement.

### SUMMARY OF THE INVENTION

The major object of the present invention is to provide an optical chassis pasted with plating film reflection thin plates, which may reduce the number of parts inside the optical chassis, save the time and the cost for assembly and manufacture, and avoid the occurrence of reflection element loose and position deviation.

Another object of the present invention is to provide an optical chassis pasted with plating film reflection thin plates, in which the reflection elements may be designed and manufactured by the method of modularization. And each element is directly pasted on the inside walls of the shell body of an optical chassis. It will greatly simplify the flow paths of assembly and save laboring time and cost.

Further another object of the present invention is to provide an optical chassis pasted with plating film reflection thin plates, in which the reflection elements each is non-glass and structured with flexible thin plate, and in which one side surface is arranged with a plating film of reflection material. And, the thin plate arranged with plating film is manufactured by the method of batch production. On the same die plate, plural thin plates arranged with plating film are formed. When the assembly of the optical chassis is under proceeding, just only one piece of the thin plates formed on the die plate is stripped off and pasted onto the fixed connection surface of the shell body. The procedure is very easy, timesaving and low cost. Furthermore, the non-glass structure of the flexible thin plates can be easily processed, bent or designed to a reflection element with curved surface or irregular shape according to special requirement.

To achieve the above-mentioned objects, the optical chassis pasted with plating film reflection thin plates includes:

a shell body, which has a hollow accommodation space, wherein a pair of opposite inside walls are defined;

plural reflection elements, which are provided inside the accommodation space of the shell body with appropriate, corresponding angles and may make appropriate reflections on the light that enters into the shell;

a lens set, which may focus the light reflected by the reflection elements; and

an imaging apparatus, through which the focused light may be imaged on it and be transferred into image data;

the characteristics are:

several inter-corresponding connection planes, formed on the two corresponding inside walls of the accommodation space of the shell body with predetermined angles and positions, provide the connection and position for the plural reflection elements. Each reflection elements are non-glass materials and thin plate structured. One side surface of the thin plate is arranged with plating film of reflection material. Each reflection element in thin plate structure is directly connected and positioned on the connection plane of the shell body by a method of pasting.

In a preferable embodiment, one side surface of the thin plate of the reflection element is arranged with plating film, while another side surface is coated with glue provided for directly pasting the thin plate onto the connection plane.

In another preferable embodiment, the connection planes are coated with glue provided for the direct pasting of thin plates of reflection elements.

Preferably, the material of the thin plates may be one kind of the following: paper, plastic, macromolecular polymer, glass fiber, rubber and other metal thin plates.

Preferably, the thin plates may be made of flexible material provided for reflection elements, which are appropriately bent to curved shapes.

Preferably, the thin plates are narrow long thin plates with unequal widths. Near the center of the thin plates the width is narrower, while near two end edges of the thin plates the width is wider.

To make the esteemed review committee can further understand and recognize the present invention, a detailed description in accordance with several accompanying diagrams are as following:

### BRIEF DESCRIPTION OF THE DRAWINGS

FIG. 1 is a three-dimensional illustration for a preferable embodiment of the prior optical scanner.

FIG. 2 is an A-A cross-section-view diagram for an optical chassis of the prior optical scanner in FIG. 1.

FIG. 3 is a cross-section-view diagram of an optical chassis pasted with plating film reflection thin plates according to the first embodiment of the present invention.

FIG. 4 is an enlarged diagram for the B part in FIG. 3 and an illustration for explaining how a thin plate is pasted onto the inside wall of a shell body of an optical chassis of the present invention.

FIG. 5 is an embodiment of responding table of pattern numbers of modularized elements, as the reflection thin plates of the present invention are designed and manufactured with method of modularization.

FIG. 6 is an embodiment illustration for the batch production of the thin plates of the present invention.

FIG. 7 is an embodiment for the thin plates shown in FIG. 5 with pattern numbers C1, C2, and C3.

FIG. 8 is an embodiment for the thin plates shown in FIG. 5 with pattern numbers E1, E2, and E3.

FIG. 9 is an embodiment illustration for the thin plates of the present invention, which can be made of flexible material and bent to a curved shape.

FIG. 10 is an embodiment illustration for the thin plates of the present invention, which can be designed to an irregular shape.

### DETAILED DESCRIPTION OF THE PREFERRED EMBODIMENT

One characteristic of an optical chassis pasted with plating film reflection thin plates of the present invention is: the prior reflection mirror elements, made of glass material, are changed by the thin plates of flexible material to be produced. The reflection material is plated on one side surface of the thin plate, and the glue is coated on the other side surface of the thin plate. The thin plate, coated with glue, may be directly pasted onto appropriate position of an optical chassis as the reflection element. Not only the present invention completely gets rid of the prior positioning devices, such as spring pieces, fixtures, screws, and the like, but also it decreases the number of parts, saves assembly time and lowers the cost of production. And, further it is without lowering the quality of image scanning, which is resulted from no loose or no movement of the reflection elements. In addition, for practical needs, the thin plate with flexible material may be easily bent or manufactured to curved face or irregular shape according to requirement.

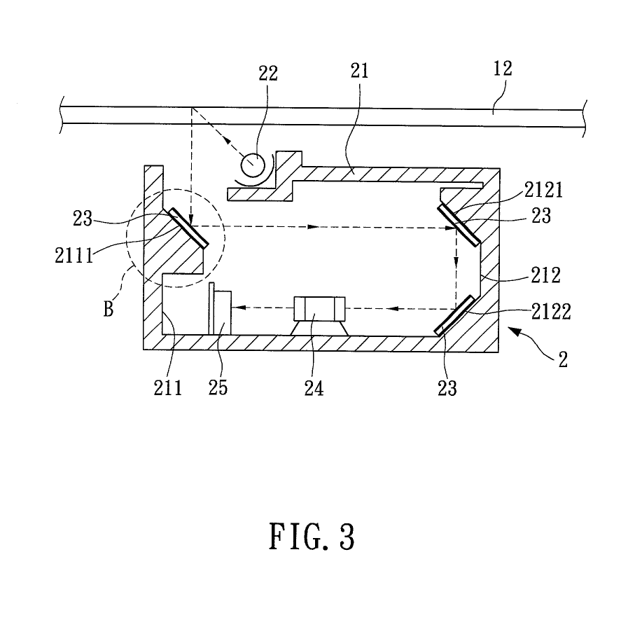

Please refer to FIG. 3, which shows an illustration of the first preferable embodiment of the optical chassis 2 pasted with plating film reflection thin plates of the present invention. The optical chassis 2 pasted with plating film reflection thin plates includes: a shell body 21, a light source 22, plural reflection elements 23, a lens set 24 and an imaging apparatus 25.

The shell body 21, which has a hollow accommodation space, wherein there are two opposite inside walls 211, 212. On the two opposite inside walls 211, 212 of the interior accommodation space of the shell body 21, several connection planes 2111, 2121, 2122 with predetermined angles and corresponding positions are provided for connection and positioning with plural reflection elements 23. Wherein, the connection planes 2111, 2121, and 2122 are formed directly on two opposite inside walls 211, 212 of the shell body 21 by method of plastic injection to one body.

After the light source 22 installed on appropriate position of the upper side of the shell body 21 provides light emitting onto the document window glass 12, the reflection light enters into the shell body 21 and is appropriately reflected and changed direction by reflection elements 23 which are arranged with appropriate angles. The reflected and direction-changed light is focused by the lens set 24 and formed an image on the imaging apparatus 25, by which the scanned image is changed into electronic signals. In this preferable embodiment, the imaging apparatus 25 is a charge-coupling device (CCD), even can be an image pick-up apparatus of CMOS.

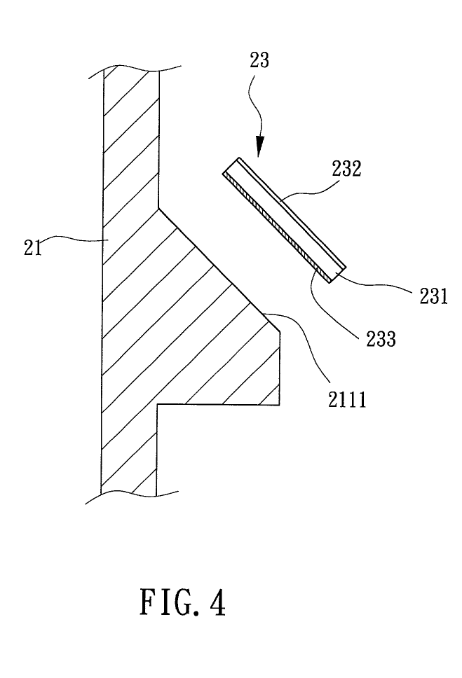

As shown in FIG. 4 which is an enlarged diagram for the B part in FIG. 3 and an illustration for explaining how a thin plate is pasted on the inside wall of a shell body of an optical chassis of the present invention. In this preferable embodiment, each reflection elements 23 is made of non-glass material and the structure for a thin plate 231 is a flexible material. A plating film 232 of reflection material is arranged on one side surface of the thin plate 231 and glue 233 is coated on another side surface of the thin plate 231. So, the reflection element 23 of the structure of each thin plate 231 is directly connected and positioned by pasting method onto the connection planes 2111, 2121, and 2122 of the shell body 21. Since the thin plates 231 of the present invention are directly pasted onto the connection planes of the shell body 21 by the glue 233, so they can save time, labor and reduce cost. Not only it is unnecessary to worry about the quality lowering down influenced by the loose and movement of prior positioning devices, such as spring pieces, fixtures, and screws, etc., but also it may further reduce the volume of the optical chassis 2 of the present invention by omitting these positioning devices.

In a preferable embodiment, the reflection materials of the plating films 232 may be silver, chromium, aluminum, platinum or other material with good reflection of light. The plating films 232 are formed on the reflection thin plates 231 by evaporating sputtering, sputtering, chemical deposition or other methods. The thickness of the plating films 232 can be a single layer or multi-layer.

In a preferable embodiment, the glue 233 is general glue, applied to connect materials of plastic or metal, for example, is used in stick tape or stick tape with double faces. In another embodiment, the applied glue 233 can also be thermo-melting materials and make the thin plate 231 of the reflection elements 23 connect onto the connection planes 2111, 2121, 2122 by the pasting method of hot press. And, in another further embodiment, the glue 233 of the present invention can also be coated on the connected planes 2111, 2121, and 2122 or coated on both surfaces of the connection planes and the thin plates for the convenience of pasting the thin plate 231 of the reflection element 23 onto the connection plane.

Preferably, the material of the thin plate 231 of the present invention may be one kind of following materials: paper, plastic, macromolecular polymer, glass fiber, rubber, metal sheet, or other flexible non-glass materials. One more thing worth mentioning is that the so-called flexible materials are not referred to the soft materials. But a material has an appropriate hardness to keep the thin plate 231 itself with enough flatness to reach fair effect of light reflection. Also, when applied by an external force, it can be bent to specific degree to constitute a curved surface of the reflection element 23 and not resulted to be broken. And, the flexible materials can also be relatively easy processed into different shapes and appropriately applied to many wide scopes of field. Relatively, because the hardness and brittleness of glass are very high, not only it is impossible to bend the prior reflection mirrors constituted with glass into curved face, but also its application scope is quite limited.

In another embodiments described thereinafter, since most elements are identical or similar to the above-mentioned embodiments, so same names and reference numbers are assigned to the identical or similar elements without repetitious description and only another character is appended to the original number for the purpose of distinguishing.

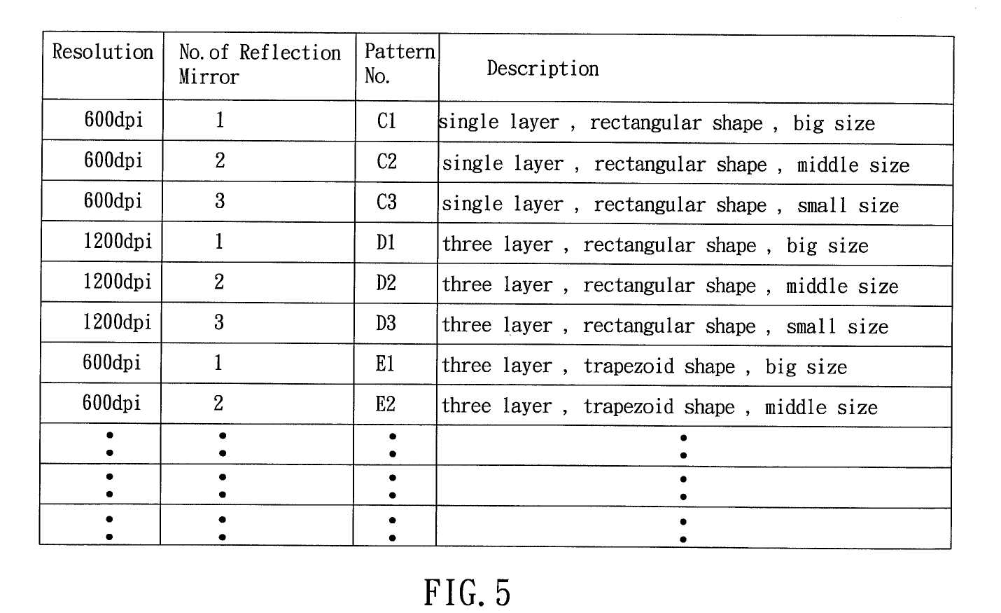

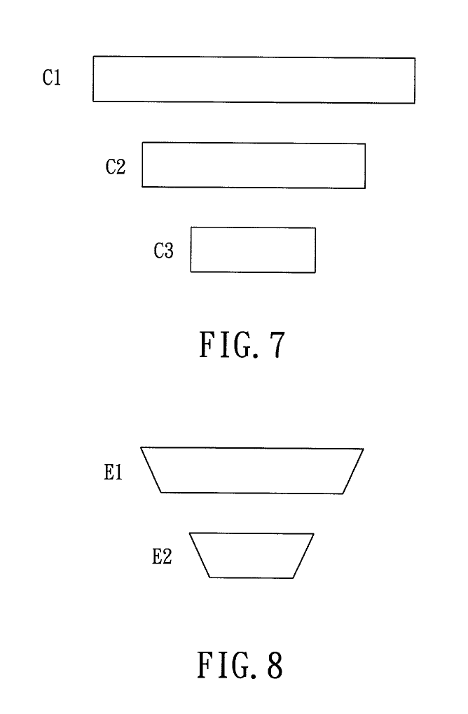

Please refer to FIG. 5, which is an embodiment of responding table of pattern numbers of modularized elements, as the reflection thin plates 231 of the present invention are designed and manufactured with method of modularization. The reflection elements 23 (reflection mirrors) of the present invention is constituted by the thin plates 231 (of a flexible material), in which two side surfaces are arranged respectively with reflection materials of plating films 232 and glue 233. And, the thin plate 231 of the flexible material is very suitable to be manufactured by the method of modularized batch production. So, its cost is much cheaper than that of prior glass reflection mirror. As shown in FIG. 5, for an optical chassis 2 of a scanner of low cost with 600 dpi resolution, to lower down the manufacture cost of the reflection elements, only one layer of plating film of reflection material plated on the thin plate 231 is enough. And, the thin plate 231 with narrow long rectangular shape is selected. Different thin plates 231 with different sizes are provided to each different reflection element 23 (Because the focusing effect of the lens 24, the closer to lens 24, the smaller size of the thin plate is). The thin plates 231 (i.e. the reflection elements 23) with pattern numbers C1, C2, and C3 shown in the table of FIG. 5 can be appropriately applied to an optical chassis 2 of a low cost scanner with 600 dpi resolution. Please refer to FIG. 7, which is an embodiment for the thin plates shown in FIG. 5 with pattern numbers C1, C2, and C3. As for an optical chassis 2 of a high price scanner with 1200 dpi resolution, a thin plate 231 with plating film that is plated with three layers or multi-layer of reflection material can be used as a reflection element 23. (For example, the narrow long rectangular shaped thin plate with pattern numbers D1, D2, D3 shown in the table of FIG. 5). The plating film with three layers of reflection material will effectively improve the light reflection effect of the reflection element and avoid the decay of light caused by the phenomena of absorption and scattering. However, its cost is relatively higher. In another embodiment, when the reflection element 23 of the present invention is applied to a single mirror of an optical chassis of double reflection mirrors with multi-reflection, (please refer to “An Optical Length Apparatus with Multi-Reflection, Double Mirrors” with R.O.C. patent no. 303037), the thin plate 231, with narrow long trapezoid-shaped structure and three layers plating film, and with pattern numbers E1, E2, and E3 as shown in the table of FIG. 5, can be selected. Please refer to FIG. 8, which is an embodiment for the thin plates shown in FIG. 5 with pattern numbers E1, E2, and E3. In this embodiment, the major reason for the application of the thin plate with trapezoid-shaped structure is that during the procedure of multi-reflection in a same mirror, in similar effect, the closer to the lens, the smaller size of the thin plate will be designed. So, the thin plate can be designed as a trapezoid-shaped structure to reduce the consumption of material and the occupied volume.

The biggest benefit for the design and production of the thin plate by the method of modularization is described as following:

During the procedure of production and assembly of the optical scanner, by just referring to the “Pattern Number” column shown in FIG. 5, then the assembly personals know what kinds of thin plated will be used to assembly the optical chassis (a thin plate with same “Pattern Number” also can be used onto various optical chassises with different regulation formation). If further in coordination with the technical characteristic that the thin plate 231 of the present invention is directly pasted on to the connection planes 2111, 2121, 2122 of the shell body 21, then, relative to the optical chassis 2 of the present invention, the assembly and production time will be greatly reduced, the needed labor power will be greatly lowered and the production cost will be greatly shrunk.

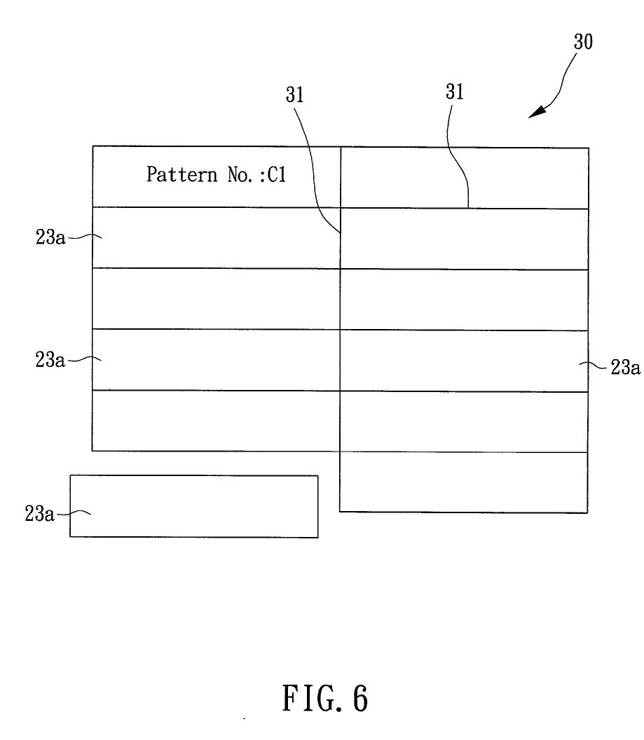

Please refer to FIG. 6, which is an embodiment illustration for the batch production of the thin plates (reflection elements) of the present invention. In this preferable embodiment, the reflection element 23a arranged with thin plate of plating film is manufactured by the method of batch production. And, plural reflection elements 23a arranged with thin plate of plating film are formed simultaneously on a die plate 30. Between each reflection element, a cutting line 31 is provided for distinguishing, on which the separation of each reflection element will be easily made by cutting an appropriate depth in advance. When the assembly of the optical chassis 2 is in proceeding, one of the reflection elements 23a that are on the die plate 30 is torn (or snapped) off along the cutting line 31. After the reflection elements 23a have been torn off, then they can be pasted and positioned onto the connection planes 2111, 2121, and 2122 of the shell body 21 to further improve the assembly efficiency.

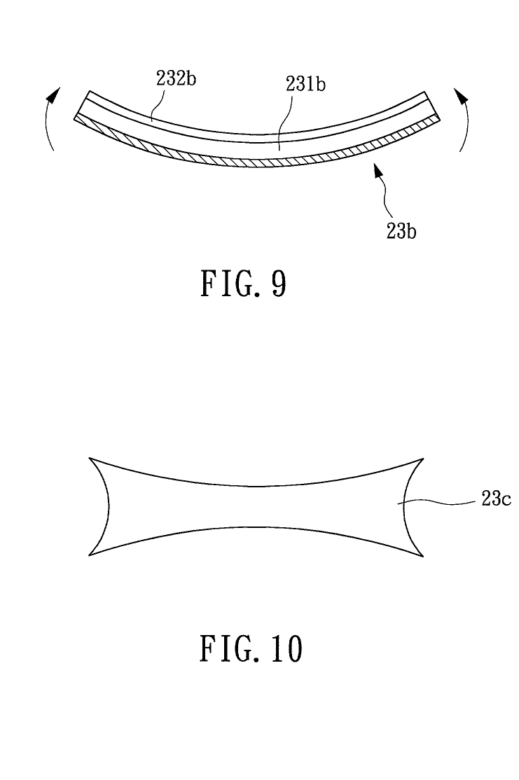

Please refer to FIG. 9, which is an embodiment illustration for the thin plates of the present invention, which can be made of flexible material and bent to a curved shape. An effect of light focusing may be resulted on the light reflection face (i.e. face of the plating film 232b) to proceed a small range of light compensation during scanning time by a little bending the thin plate 231b (the reflection element 23b) to a shape of a little curved face. In another preferable embodiment, the thin plate can also be bent to an angle (less than 180 degree) to appropriately change the angle of light reflection (not shown in the figure).

Please refer to FIG. 10, which is an embodiment illustration for the thin plates of the present invention, which can be designed to an irregular shape. Because the thin plate (the reflection element 23c) of the present invention is made of flexible material and can be processed very easily, the reflection element 23c with narrow long indented-line shape can be designed and manufactured as shown in FIG. 10 to make the reflection element 23c become a narrow and long-shaped thin plate, in which the width close to center is narrower and the widths close to two end edges are wider. The reflection element 23c of this kind can be coordinated with a general narrow long light source (light tube) that has characteristic of relative stronger light brightness near center and relative weaker light brightness near two ends. So, the reflection area of the two ends of the reflection elements 23c is larger and can reflect more light, while the reflection area near center place of the reflection element 23c is smaller and can reflect less light. For whole body of the reflection element 23c (thin plate), the further uniform reflection effect of light brightness will achieve the light compensation operation in small scope during the proceeding of scanning.

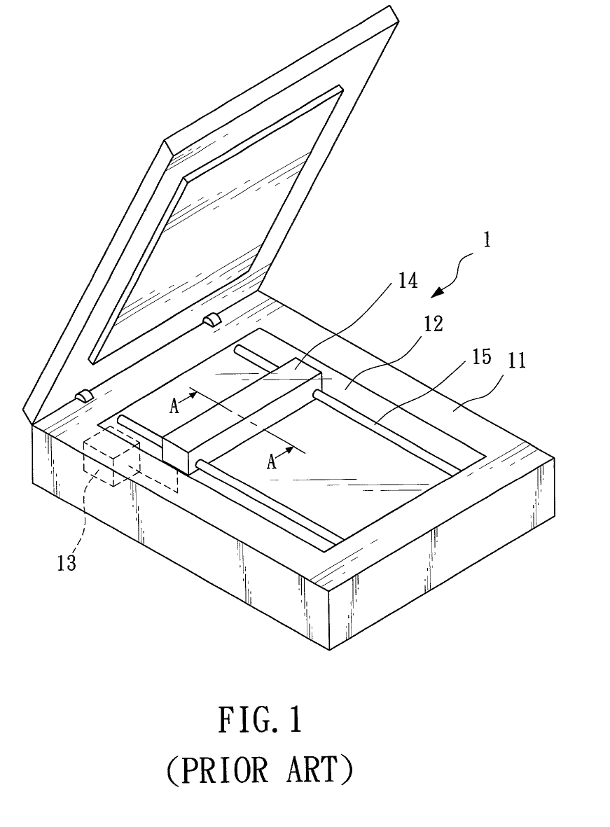

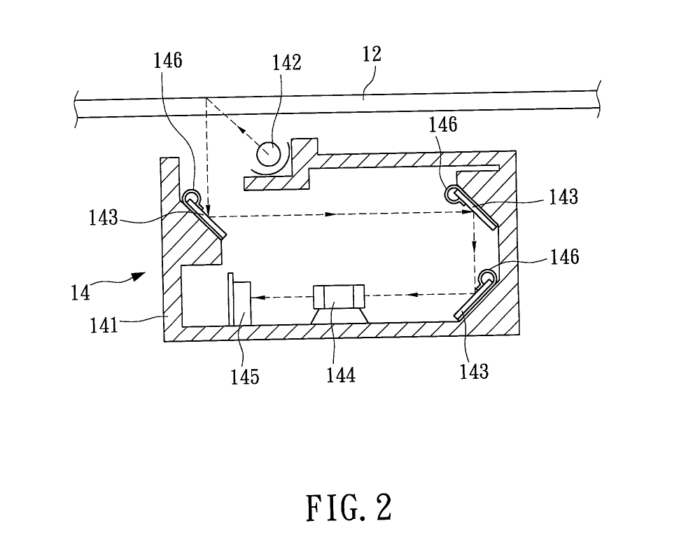

In summary, the optical chassis pasted with reflection thin plate of plating film of the present invention has at least following advantages relative to the prior technology shown in FIG. 1 and FIG. 2:

(1)The production cost is further lowered. The thin plate is made of flexible materials, such as paper, plastic, macromolecular polymer, glass fiber, rubber, metal sheet, and other non-glass. Not only different shapes are further processed easily, but also its production cost, which is cheaper than that of glass, is provided.

(2)Appropriate bending is possible. The thin plate of flexible material can be appropriate bending and applied for special purposes (for example, on an optical chassis proceeding light focus effect). The scope of application is further wider.

(3)Easy assembly and reducing labor. The thin plate is pasted directly onto the connection plane of the shell body. Not only the labor and cost are saved, but also it is unnecessary to worry about the quality lowering down of image scanning influenced by the loose or movement of the prior positioning structures, such as spring piece, fixture, or screw, etc. And, the volume of the optical chassis of the present invention can be further reduced due to the omission of these positioning structures.

(4)Modularization and batch production. The thin plate of the present invention can be designed by the method of modularization and be manufactured by the batch production. Not only the production efficiency is raised, but also the cost is further lowered down in great amount.

The above-mentioned preferable embodiments are applied to describe the present invention in detail, however, they are not the limited scope of the present invention. For example, although the above-mentioned preferable embodiments of the present invention take the optical chassis of the optical scanners as embodiments, but they are also suitable for an optical chassis of a copy machine. Furthermore, although the present invention is explained by an example of an optical chassis with three pieces of reflection mirror, but it also suitable for the optical chassis with two or four pieces of reflection mirror. Therefore, it is apparent to all the persons who well-know such technologies that appropriate and small variation and adjustment still possess the merit of the present invention and are also still within the spirit and the scope of the present invention.

What the claimed is:

1.An optical chassis pasted with plating film reflection thin plates includes:
a shell body, which has a hollow accommodation space, wherein a pair of opposite inside walls are defined;
plural reflection elements, which is provided inside the accommodation space of the shell body with appropriate, corresponding angles and may make appropriate reflections on the light that enters into the shell;
a lens set, which may focus the light reflected by the reflection elements; and
an imaging apparatus, through which the focused light may be imaged on it and be transferred into image data;
the characteristics are:
several inter-corresponding connection planes, formed on the two corresponding inside walls of the accommodation space of the shell body with predetermined angles and positions, provide the connection and position for the plural reflection elements. Each reflection elements are non-glass materials and thin plate structured. One side surface of the thin plate is arranged with plating film of reflection material. Each reflection element in thin plate structure is directly connected and positioned on the connection plane of the shell body by a method of pasting.

2.An optical chassis pasted with plating film reflection thin plates according to claim 1, a light source provided on an appropriate position of an upper side of said shell body is further included.

3.An optical chassis pasted with plating film reflection thin plates according to claim 1, wherein said imaging apparatus is a charge-coupling device (CCD).

4.An optical chassis pasted with plating film reflection thin plates according to claim 1, wherein said reflection planes are directly formed on two inside walls of said shell body by a method of plastic injection forming to one body.

5.An optical chassis pasted with plating film reflection thin plates according to claim 1, wherein one side surface of said thin plate of said reflection element is arranged with plating film, while another side surface is coated with glue provided for directly pasting said thin plate onto said connection plane.

6.An optical chassis pasted with plating film reflection thin plates according to claim 1, wherein one side surface of said thin plate of said connection element is arranged with said plating film, while the other side surface of said thin plate is coated with glue of thermoplastic materials, by which said thin plate can be connected on to said connection plane by the method of hot press and pasting.

7. An optical chassis pasted with plating film reflection thin plates according to claim 1, wherein glue is coated on said connection plane to directly paste said thin plate of said reflection element onto said connection plane.

8.An optical chassis pasted with plating film reflection thin plates according to claim 1, wherein the material of said thin plate may one kind of following: paper, plastic, macromolecular polymer, glass fiber, rubber, and metal sheet.

9.An optical chassis pasted with plating film reflection thin plates according to claim 1, wherein said thin plate is made of flexible materials, which can make said thin plate be appropriately bent to curved-face-shaped reflection element.

10.An optical chassis pasted with plating film reflection thin plates according to claim 1, wherein said thin plate is a narrow long rectangular shaped thin plate.

11.An optical chassis pasted with plating film reflection thin plates according to claim 1, wherein said thin plate is a narrow long trapezoid shaped thin plate.

12.An optical chassis pasted with plating film reflection thin plates according to claim 1, wherein said thin plate is a width unequal and narrow long shaped thin plate, in which width close to center is narrower and widths close to two end edges are wider.

13.An optical chassis pasted with plating film reflection thin plates according to claim 1, wherein said reflection elements are arranged with said thin plate of plating film can be designed and manufactured by the modularization method.

14.An optical chassis pasted with plating film reflection thin plates according to claim 1, wherein said reflection elements are arranged with said thin plate of plating film can be manufactured by the method of batch production. Plural thin plates with plating film are formed simultaneously on a same die plate. When the assembly is proceeding for said optical chassis, just one piece of said thin plates on the die is torn off, then, pasted and positioned onto said connection plane of said shell body.

15.An optical chassis pasted with plating film reflection thin plates according to claim 14, wherein said separation method of said thin plate off die plate is bending breaking and tearing off.

16.An optical chassis pasted with plating film reflection thin plates according to claim 1, wherein said optical chassis is applied to an optical scanner.

17.An optical chassis pasted with plating film reflection thin plates includes:
a hollow shell body; and
plural reflection elements, which are arranged in the inside walls of the hollow shell body with appropriately corresponding angles;
the characteristics are:
several connection planes are formed on the inside walls of the shell body for the connection and positioning of the plural reflection elements. Each of the reflection elements is structured with thin plate of non-glass material. And, one side surface of the thin plate is arranged with plating film of reflection material. Furthermore, the thin plate with plating film is manufactured by the method of batch production. Plural thin plates with plating film are formed simultaneously on a same die plate. When the assembly is proceeding for the optical chassis, just one piece of the thin plates on the die is torn off, then, pasted and positioned onto the connection plane of the shell body.

18.An optical chassis pasted with plating film reflection thin plates according to claim 17, wherein said reflection planes are directly formed on two inside walls of said shell body by a method of plastic injection forming to one body.

19.An optical chassis pasted with plating film reflection thin plates according to claim 17, wherein one side surface of said thin plate of said reflection element is arranged with plating film, while another side surface is coated with glue provided for directly pasting said thin plate onto said connection plane.

20.An optical chassis pasted with plating film reflection thin plates according to claim 17, wherein the material of said thin plate may be one kind of following: paper, plastic, macromolecular polymer, glass fiber, rubber, and metal sheet.

21.An optical chassis pasted with plating film reflection thin plates according to claim 17, wherein said thin plate is made of flexible materials, which can make said thin plate be appropriately bent to curved-face-shaped reflection element.

22.An optical chassis pasted with plating film reflection thin plates according to claim 17, wherein said reflection elements are arranged with said thin plate of plating film can be designed and manufactured by the modularization method.
